(19) United States
(12) Patent Application Publication
(10) Pub. No.: US 2003/0119354 A1
(43) Pub. Date: Jun. 26, 2003

(54) ELECTRICAL CONNECTOR HAVING IMPROVED SHIELDING

(76) Inventor: Jun Xian Liu, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/116,389

(22) Filed: Apr. 3, 2002

(30) Foreign Application Priority Data
Dec. 26, 2001 (TW) 90223022

(51) Int. Cl. H01R 12/24

(52) U.S. Cl. 439/497

(57) ABSTRACT

An electrical connector for mounting to a printed circuit board (PCB) includes a dielectric housing (3) having a mating portion (31) and a mounting portion (32), a plurality of terminals (4) received in the housing, and a shell (2) shielding the housing including a first shielding (21) surrounding the mating portion and a second shielding (22) engaging with the mounting portion. The second shielding is electrical connected with the first shielding and has an elongated shielding plate (221) attached to a front surface of the mounting portion and a pair of holding legs extending from two ends of the shielding plates, the holding legs (22a) respectively attaching to two side surfaces of the mounting portion and extending downwardly.

### FIELD OF THE INVENTION

The present invention relates to an electrical connector, and more particularly to an electrical connector having an improved Electro Magnetic Interference (EMI) shielding.

### BACKGROUND OF THE INVENTION

An electrical connector is often used for connecting a printed circuit board (PCB) with an electronic device for transmitting signals. A conventional connector generally includes a dielectric housing having a plurality of terminal-receiving cavities or passages, with a plurality of terminals received in the passages. A metal shield surrounds a substantial portion of the housing to protect at least the mating portions of the terminals from RF interference and Electro Magnetic Interference (EMI) as well as protecting the surroundings from interference radiating from the connector itself. The connector is mounted to the PCB, and the terminals have tail portions for connection, as by soldering, to circuit traces on the PCB. Such a connector often have hooks to hold the connector to the PCB, and such hooks have been provided by separate components, independent of the housing or the shield of the connector, to perform the function.

However, a problem of such structures is that the shield could not achieve a complete EMI shielding due to gaps between the shield and the PCB. Furthermore, these separate hooks cause problems in significantly increasing the fabrication and assembly costs of the connectors.

Hence, an electrical connector with an improved shielding is required to overcome the disadvantage of the prior art.

### BRIEF SUMMARY OF THE INVENTION

A main object, therefore, of the present invention is to provide an electrical connector having an improved conductive shielding performing a complete Electro Magnetic Interference (EMI) shielding function.

Another object is to provide an electrical connector having a conductive shielding integrated with hooks to perform a multitude of functions by a one-piece structure.

An electrical connector according to the present invention for mounting to a printed circuit board (PCB) includes a dielectric housing having a mating portion and a mounting portion, a plurality of terminals received in the housing, and a shell shielding the housing including a first shielding surrounding the mating portion and a second shielding engaging with the mounting portion.

The second shielding is electrical connected with the first shielding and has an elongated shielding plate attached to a front surface of the mounting portion and a pair of holding legs extending from two ends of the shielding plates, the holding legs respectively attaching to two side surfaces of the mounting portion and extending downwardly to plug in the PCB. By this structure, the Electro Magnetic Interference (EMI) shielding is complete.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an electrical connector according to the present invention.

FIG. 2 shows a second shielding of the electrical connector of FIG. 1.

FIG. 3 is an assembled view of the electrical connector of FIG. 1.

### DETAILED DESCRIPTION OF THE INVENTION

Reference will now be made in detail to a preferred embodiment of the present invention.

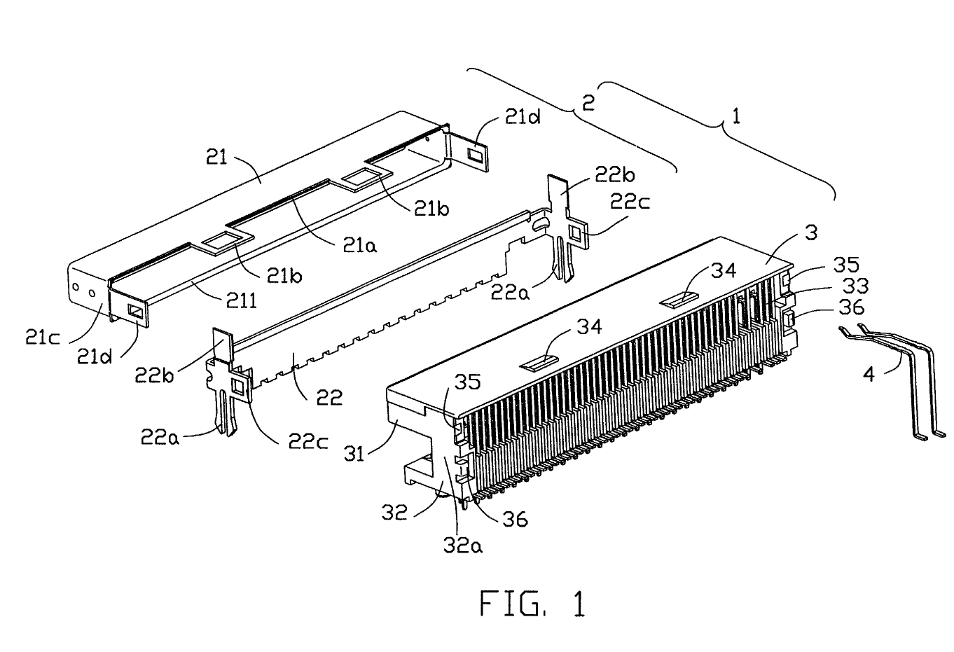

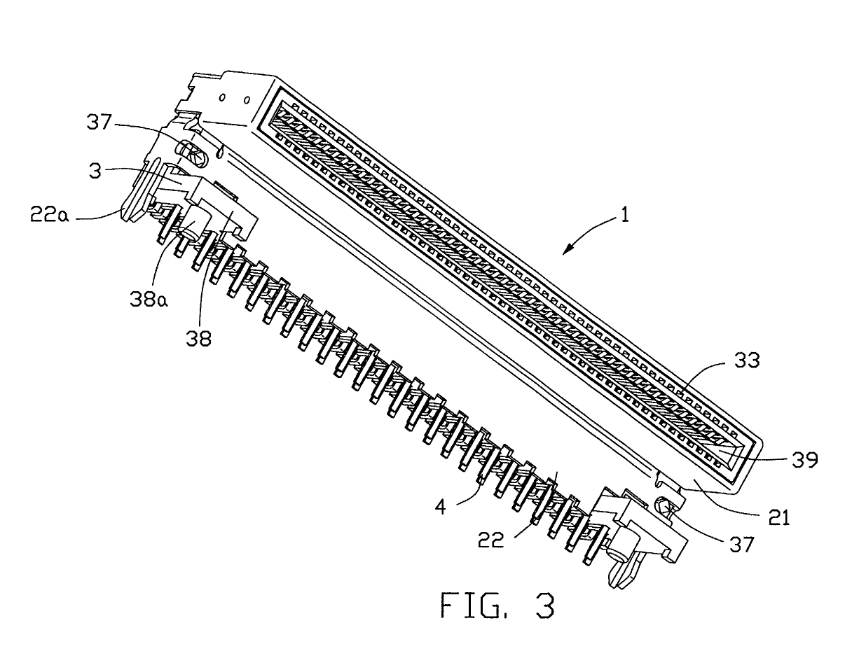

Referring to the drawings and particularly to FIGS. 1 and 3, an electrical connector 1 in accordance with the present invention comprises an elongated dielectric housing 3, a plurality of terminals 4, and an elongated conductive shell 2 having a first shielding 21 and a second shielding 22.

The dielectric housing 3 comprises a horizontal mating portion 31 for mating with an electronic device (not shown) and a vertical mounting portion 32 for mounting to a printed circuit board (PCB) (not shown). A cavity 39 is defined through the mating portion 31 and is opening forwardly. A plurality of passageways 33 is defined in the cavity and a rear surface of the mounting portion 32. A pair of top barbs 34 protrudes on a top surface of the mating portion 31. A pair of first holding blocks 35 respectively protrudes rearwardly from two side walls 32a of the mounting portion 32. A pair of second holding blocks 36 respectively protrudes rearwardly from the two side walls 32a below the pair of first holding blocks 35. A pair of third holding blocks 37 respectively protrudes forwardly from the two side walls 32a opposite to the pair of second holding blocks 36. A pair of mounting plates 38 extends forwardly and horizontally from a bottom of the mounting portion 32. A post 38a protrudes downwardly from each mounting plate 38.

The metallic first shielding 21 comprises a pair of horizontal plates 21a and a pair of vertical plates 21c to form a substantial rectangular frame. Two first tabs 21d respectively extend rearwardly from the two vertical plates 21c, with a first hole (not labeled) defined in each first tab 21d. A pair of second tabs 21b extends rearwardly from the upper horizontal plate 21a, with a second hole (not labeled) defined in each second tab 21a.

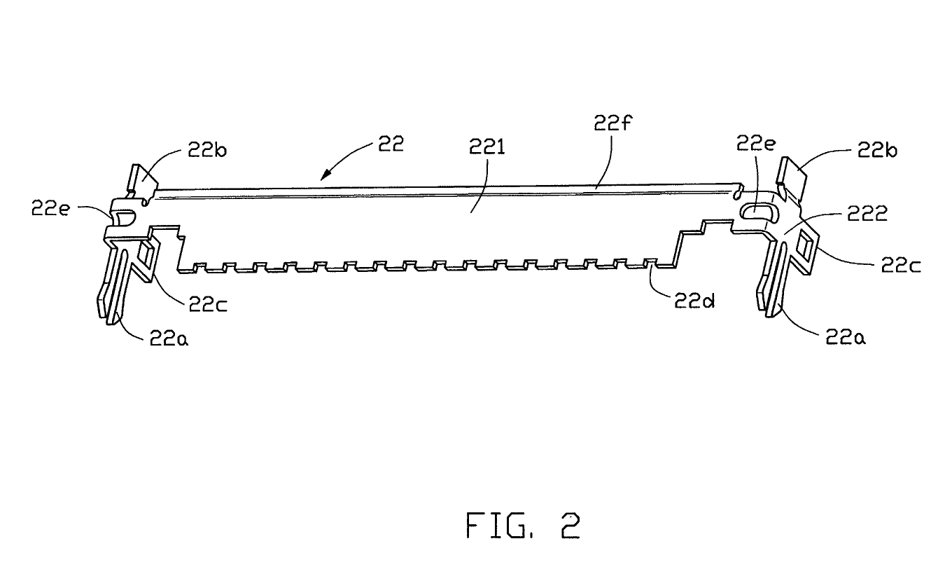

Particularly referring to FIG. 2, the second shielding 22 is formed by a one-piece sheet metal and comprises an elongated vertical shielding plate 221 and a pair of side plates 222 extending and bending rearwardly from two ends of the shielding plate 221. A pair of holding legs 22a extends downwardly from a lower edge of each side plate 222. A locking protrusion (not labeled) protrudes at a low portion of each holding leg 22a. A third tab 22c extends rearwardly from a rear edge of each side plate 222 and has a third hole (not labeled). Two shielding pads 22b extend upwardly from the side plates 222. An upper edge 22f of the shielding plate 221 is bent inwardly. A plurality of notches 22d is defined in a lower edge of the shielding plate 221. A pair of fourth holes 22e are respectively defined in joints between the shielding plate 221 and the pair of side plates 222.

Particularly referring to FIG. 3, in assembly, the plurality of terminals 4 are received in corresponding passageways 33 with respective tail portions (not labeled) extending downwardly out of the housing 3 to solder with the PCB.

The second shielding 22 engages with the mounting portion 32 by attaching the shielding plate 221 to a front surface of the mounting portion 32 and by attaching the side plates 22c and the shielding pads 22b to outer surfaces of the side walls 32a. The third tabs 22c are bent to hold on the rear surface of the mounting portion 32 by the third holes of the third tabs 22c engaging with the second holding blocks 36. The fourth holes 22e engage with the third holding blocks 37. The locking portions of the holding legs 22a extend downwardly to be lower than the bottom of the mounting portion 32.

The first shielding 21 engages around the mating portion 31, with an inner surface of the first shielding 21 abutting against an outer surface of the mating portion 31. The second tabs 21b are held on the top surface of the mating portion 31 by engaging the second holes of the second tabs 21b with the top barbs 34. The first tabs 21d attach with outer surfaces of the shielding pads 22b and are bent to hold on the rear surface of the mounting portion 32 by engaging the first holes of the first tabs 21c with the first holding blocks 35. The upper edge 22f of the second shielding 22 abuts against a rear edge 211 of the lower horizontal plate 21a to prevent a gap between the first shielding 21 and second shielding 22.

By such arrangement disclosed above, the shell 2 and the housing 3 are assembled firmly, and a complete and reliable Electro Magnetic Interference (EMI) shielding is obtained in this design. In use, when the electrical connector is mounted to the PCB, the holding legs 22a and the posts 38a are plugged in the PCB, and the mounting plates 38 attach with the PCB to stabilize the mounting. The holding legs 22a can be connected to a grounded circuit trace on the PCB to further improve the EMI shielding of the shell 2.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector for mounting to a printed circuit board (PCB) comprising:
an elongated dielectric housing including a mating portion and a mounting portion;
a plurality of terminals received in the housing; and
a shell including a first shielding surrounding the mating portion and a second shielding engaging with the mounting portion, the second shielding having an elongated shielding plate attached to a front surface of the mounting portion and a pair of holding legs extending from two ends of the shielding plates, the holding legs respectively attaching to two side surfaces of the mounting portion and extending downwardly, an upper edge of the second shielding bending slightly and abutting against a rear edge of the first shielding.

2. The electrical connector as claimed in claim 1, wherein the shielding plate and the holding legs are formed by a one-piece sheet metal.

3. The electrical connector as claimed in claim 1, wherein the shielding plate includes a plurality of notches a lower edge thereof.

4. The electrical connector as claimed in claim 1, wherein a pair of holes are respectively defined in joints between the shielding plate and the pair of holding legs, and engage with a pair of first holding blocks protruding on the front surface of the mounting portion.

5. The electrical connector as claimed in claim 1, wherein the second shielding further comprise a pair of shielding pads respectively extending upwardly from the two holding legs.

6. The electrical connector as claimed in claim 5, wherein the first shielding includes a pair of tabs extending rearwardly from the rear edge thereof, the tabs attaching with outer surfaces of the shielding pads and bending to hold on a rear surface of the mounting portion.

7. A high rise connector comprising:
an insulative housing including a vertical mounting portion and a horizontal mating portion with therein a cavity on a top portion of said mounting portion;
a plurality of terminals each with a contact portion extending into the mating portion and a tail portion extending along the mounting portion;
a first metal shield enclosing the mating portion except the cavity;
a second metal shield including an elongated plate covering a front face of said mounting portion, and a pair of board locks extending downwardly around two opposite ends of said plate; and
means around said two opposite ends of the plate for mechanically and electrically connecting said first shield and said second shield.

8. An electrical connector comprising:
an insulative housing with a plurality of contacts therein;
a first shield defining a circumferential wall with locking tabs extending rearward from said circumferential wall and latchably engaged with the housing; and
a second shield defining an elongated plate with a similar longitudinal dimension with the circumferential wall, a pair of board locks downwardly extending around two opposite ends of said plate, and a pair of pads upwardly extending around said two opposite ends; wherein
said pair of pads are sandwiched between the corresponding locking tabs and the housing.

9. The connector as claimed in claim 8, wherein a pair of locking tabs extend rearwardly from said two opposite ends and latchably engage the housing.
